(19) United States
(12) Patent Application Publication
(10) Pub. No.: US 2007/0119302 A1
(43) Pub. Date: May 31, 2007

(54) Polymers containing ionic groups for gas separation and storage

(76) Inventors: Maciej Radosz, Laramie, WY (US); Youging Shen, Laramie, WY (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/599,111

(22) Filed: Nov. 14, 2006

Related U.S. Application Data
(60) Provisional application No. 60/736,492, filed on Nov. 14, 2005.

(51) Int. Cl. B01D 53/22; B01D 59/12

(52) U.S. Cl. 96/5

(57) ABSTRACT

Polymeric materials containing ionic groups, which can be used as membranes and sorbents for separating gas components, for example, separating CO₂ from flue gas streams and from natural gas streams, and sorbents for storing gas components. Such separation materials are used for pre-combustion separations, post-combustion separations, and natural gas separations, and are alternatives to the conventional amine absorption process.

This application claims priority to U.S. patent application Ser. No. 60/736,492, filed Nov. 14, 2005.

### BACKGROUND OF THE INVENTION

The present invention relates generally to polymeric materials containing ionic groups and, more specifically to the use of polymeric materials containing ionic groups either as membranes and sorbents for gas separation, for example CO₂ separation, or as sorbents for gas storage.

Examples of recently reported membranes for CO₂ separation are amine-modified mesoporous SiO₂ (Kim, S.; Guliants, V. V.; Ida, J.; Lin, Y. S. Prepr. Symp.—ACS, Div. Fuel Chem. 48, 392, (2003)), polyimide hollow fiber (Wind, J. D., Sirard, S. M., Paul, D. R., Green, P. F., Johnston, K. P., Koros, W. J. Macromolecules, ASAP article, (2003); Wind, J. D., Staudt-Bickel, C., Paul, D. R., Koros, W. J. Ind. Eng. Chem. Res., 41, 6139, (2002), carbon nanotube (Andrews, R., Jagtoyen, M., Grulke, E., Lee, K.-H., Mao, Z., Sinnott, S. B. NASA Confer. Pub. 210948 (Proc. Sixth Appl Diamond Confer./Second Frontier Carbon Technology Joint Confer., 701, (2001)), ionic liquid (Noble, R. D., Scovazzo, P., Koval, C. A., Kieft, J. CO₂ separations using ionic liquid membranes, Abstr. Papers, 225th ACS Meeting, New Orleans, La., United States, ACS, Mar. 23-27, (2003)), liquid membrane (Kovvali, A. S.; Sirkar, K. K. Ind. Eng. Chem. Res., 41, 2287, (2002); Kovvali, A. S.; Sirkar, K. K. Ind. Eng. Chem. Res., 40, 2502, (2001)), and polyethylene oxide-containing polyimide (Okamoto, K., Umeo, N., Okamyo, S., Tanaka, K., Kita, H. Chem. Lett. 2, 225, (1993)). The challenge is to improve the membrane stability, permeability and selectivity (White, C. M., Strazisar, B. R.; Granite, E. J.; Hoffman, J. S. J. Air & Waste Manage. Assoc., 53, 645, (2003)). Recent studies suggest that materials exhibiting physicochemical interactions with CO₂, for example, polyethylene- (PEG) and amine-containing membranes have better selectivity and permeability (Patel, N. P., Miller, A. C. and Spontak, R. J. Adv. Mater., 15, 729, (2003); Okamoto et al., 1993), and nanoparticle-containing membranes have better permeability and mechanical strength at about the same selectivity (Patel et al., 2003; Zhang, J., Wen, W-Y., Jones, A. A. Macromolecules, ASAP article, (2003)). The challenge is to develop membranes with both high permeability and selectivity.

The high solubility of CO₂ in ionic liquids is known (Blanchard, L. A.; Gu, Z.; Brennecke. High-Pressure Phase Behavior of Ionic Liquid/CO₂ Systems. J. Phys. Chem. B, 105, 2437 (2001); Anthony, J. L.; Maginn, E. J.; Brennecke, J. F. Solubilities and Thermodynamic Properties of Gases in the Ionic Liquid 1-n-Butyl-3-methylimidazolium Hexafluorophosphate. J. Phys. Chem. B, 106, 7315, (2002); Bates, E. D.; Mayton, R. D.; Ntai, I.; Davis Jr., J. H. CO2 Capture by a Task-Specific Ionic Liquid. J. Am. Chem. Soc., 124, 926 (2002); Kamps, A. P.; Tuma, D.; Xia, J.; Maurer, G. Solubility of CO₂ in the Ionic Liquid [bmim][PF6]. J. Chem. Eng. Data, 48, 746 (2003)). The present invention makes use of polymer backbones that are known for their stability, but enriches them with ionic moieties that impart these backbones with unique CO₂-phillic properties.

In addition to CO2 separation and storage, these materials can be used for separation and storage of other gases that have affinity to ionic groups.

### SUMMARY OF THE INVENTION

The invention relates to polymeric compounds that are useful in gas separation and gas storage applications. The polymers have a polymeric backbone and a plurality of ionic liquid moieties attached to the polymeric backbone. The ionic liquid moieties are preferably both anions and cations. In a preferred embodiment, the anions include amides, imides, methanes, sulfanes and sulfonates. In a preferred embodiment, the cations include monosubstituted imidazoliums, disubstituted imidazoliums, trisubstituted imidazoliums, pyridiniums, pyrrolidiniums, phosphoniums, ammoniums, guanidiniums, and isouroniums. The polymeric compounds are particularly useful in the separation and storage of carbon dioxide (CO₂), nitrogen oxides (NOₓ), sulfur oxides (SOₓ), hydrogen sulfide, and ammonium. The polymeric compounds are also useful in the separation of flue, combustion, gasification, natural, and other gas mixtures.

### BRIEF DESCRIPTION OF THE DRAWINGS

FIG. 1a is a generic structure of polymers with ionic moieties of the present invention wherein x indicates cations and y indicates anions; FIGS. 1b and 1c illustrate specific examples of the general structure of FIG. 1a.

FIG. 2 is a pair of exemplary synthesis schema of for the preparation reactions from monomers carrying ionic liquid moieties.

FIG. 3 is an illustration of an exemplary synthesis scheme of a polymer reaction approach, in which ionic liquid moieties are attached to a previously synthesized polymer.

### DETAILED DESCRIPTION OF PREFERRED EMBODIMENTS

Synthesis of Polymers from Monomers Carrying Ionic Liquid Moieties

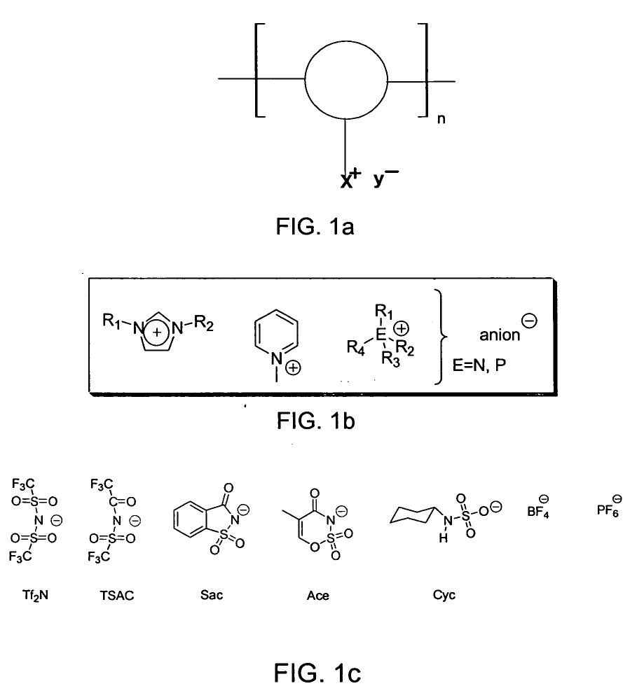

Polymers can be synthesized by polycondensation reactions or other polymerization techniques from small molecules carrying ionic liquid moieties. A general polymer structure is shown in FIG. 1a.

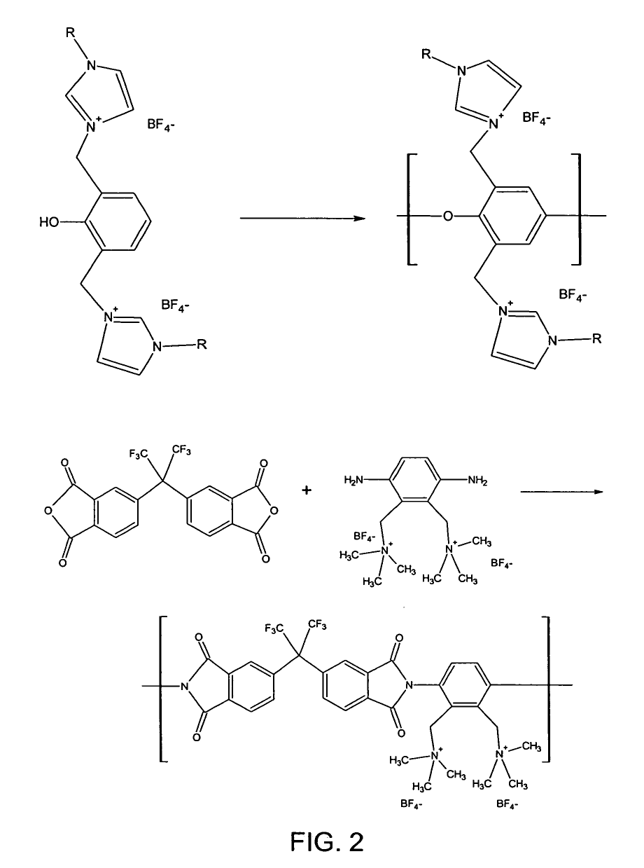

In FIG. 1a, x⁺ and y⁻ are cations and anions generally used in small-molecule ionic liquids. For example, anions can be amides, and imides, methanes, sulfates and sulfonates, and the like. Cations can be monosubstituted imidazoliums, disubstituted imidazoliums, trisubstituted imidazoliums, pyridiniums, pyrrolidiniums, phosphoniums, ammoniums, guanidiniums, isouroniums, and the like. Specific examples of preferred-moieties are shown in FIGS. 1b and c. Each repeat unit may contain up to several x,y units, which may be different and may occupy different positions. Examples of preparation reactions are shown in FIG. 2.

Synthesis via Polymer Reaction

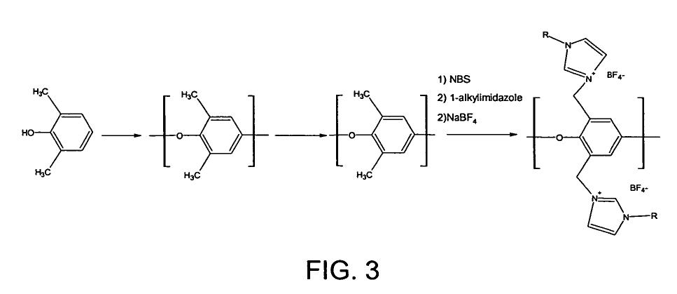

The polymer containing ionic moieties can also be prepared by the polymer reaction method. In this approach, the original polymer (herein referred to as a polymer backbone) is first synthesized. Then, subsequent reactions attach ionic liquid moieties to the backbone. FIG. 3 shows an example.

Fabrication of Polymeric Membranes

Such polymers are easily fabricated into membranes, including disc, hollow fiber and other shapes, as may be suitable for CO₂ separation. Due to the high solubility of CO₂ in such polymers, both the selectivity and permeability of CO₂ through the membrane are expected to be high (permeability=solubility×diffusivity). Furthermore, such polymers are thermally stable; the original polymers to which the ionic groups are attached are known to be thermally stable. Crosslinking is known to further increase their stability.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. A polymeric compound useful in gas separation and storage comprising:
(a) a polymeric backbone; and
(b) a plurality of ionic liquid moieties attached to the polymeric backbone.

2. A polymeric compound as defined in claim 1, wherein the ionic liquid moieties comprise both anions and cations.

3. A polymeric compound as defined in claim 2, wherein the anions are selected from the group consisting of amides, imides, methanes, sulfanes and sulfonates.

4. A polymeric compound as defined in claim 2, wherein the cations are selected from the group consisting of monosubstituted imidazoliums, disubstituted imidazoliums, trisubstituted imidazoliums, pyridiniums, pyrrolidiniums, phosphoniums, ammoniums, guanidiniums, and isouroniums.

5. A method of separating a mixture of gases into one or more constituents, comprising the step of passing the mixture of gases across a structure formed of polymeric compound as defined in claim 1.

6. A method as defined in claim 5, wherein the mixture of gases comprises a separable gas selected from the group consisting of CO2, nitrogen oxides (NOx), sulfur oxides (SOx), hydrogen sulfide (H2S), and ammonium.

7. A method as defined in claim 5, wherein the mixture of gases is selected from the group consisting of flue, combustion, gasification, natural gas mixtures.

8. A method of storing a gas, comprising the step of passing the gas across a structure formed of polymeric compound as defined in claim 1.

9. A method as defined in claim 8, wherein the gas comprises a separable gas selected from the group consisting of CO2, nitrogen oxides (NOx), sulfur oxides (SOx), hydrogen sulfide (H2S), and ammonium.
